(19) United States
(12) Patent Application Publication
(10) Pub. No.: US 2019/0196845 A1
(43) Pub. Date: Jun. 27, 2019

(54) EQUIPMENT CONTROL METHOD, APPARATUS, ELECTRONIC DEVICE AND STORAGE MEDIUM

(71) Applicant: Beijing Chuangyu Technology Co., Ltd., Beijing (CN)

(72) Inventors: Huijun Ma, Beijing (CN); Pan Han, Beijing (CN); Ang Zhao, Beijing (CN)

(21) Appl. No.: 16/050,604

(22) Filed: Jul. 31, 2018

(30) Foreign Application Priority Data
Dec. 25, 2017 (CN) 201711424222.6

(51) Int. Cl. G06F 9/445; G06F 8/30

(52) U.S. Cl. CPC G06F 9/44505; G06F 8/30

(57) ABSTRACT

The embodiments of the present disclosure provide an equipment control method, apparatus, electronic device and storage medium. The method includes determining one or more equipment control sub-processes involved in control process of equipment to be controlled and execution logic between each equipment control sub-process; obtaining code corresponding to the equipment control sub-process; generating an encoding configuration file corresponding to the control process according to the code corresponding to each equipment control sub-process and the execution logic between each equipment control sub-process; and controlling the equipment according to the encoding configuration file. By applying the solutions provided by the embodiments of the present disclosure, repetitive hard-coding are avoided, the debugging and development at a later stage are simplified, and the development efficiency is improved.

### CROSS-REFERENCE TO RELATED APPLICATIONS AND CLAIM OF PRIORITY

This application claims priority to Chinese Application No. 201711424222.6, filed Dec. 25, 2017, the entire contents of which are fully incorporated herein by reference in its entirety.

### TECHNICAL FIELD

The embodiments of the present disclosure relate to the technical field of semiconductor, and particularly to an equipment control method, apparatus, electronic device and storage medium.

### BACKGROUND

In the production process of photovoltaic semiconductors, for different types or models of equipments, even if the equipment control sub-processes are similar or the same, each type or model of equipment must separately correspond to a set of control programs when writing control codes; and these equipment control sub-processes will be hard-coded in each set of control programs.

However, the existing hard-coded control method would cause some repetitive work, such as multiple developments on a same process. For example, in the production process of semiconductors, same or similar equipment control sub-processes are partially existed in the control processes of MOCVD (Metal-organic Chemical Vapor Deposition) and PVD (Physical Vapor Deposition) equipment, such as the loading/unloading of substrates. During the writing of the control programs corresponding to the control processes of MOVCD equipment, the equipment control sub-process for the loading/unloading of substrates needs to be encoded; meanwhile, during the writing of the control programs corresponding to the control processes of PVD equipment, the equipment control sub-process for the loading/unloading of substrates also needs to be encoded. In this way, for the same equipment control sub-process, the control programs respectively corresponding to MOCVD equipment and PVD equipment are encoded, that is, there is a repetitive coding. Furthermore, once a certain equipment control sub-process has a design flaw or new demands arise at a later time so that expansions or modifications are needed, code changes for all control programs of the existing devices that involve the equipment control sub-process are required, which has a heavy workload.

### SUMMARY

With respect to the existing hard-coded control method, the embodiments of the present disclosure provide an equipment control method, apparatus, electronic device and storage medium, so as to avoid repetitive hard-coding, simplify the debugging and development at a later stage, and improve the development efficiency.

In one respect, the embodiments of the present disclosure provide an equipment control method, including:
determining one or more equipment control sub-processes involved in control process of equipment to be controlled and execution logic between each equipment control sub-process;
for each of the equipment control sub-process, obtaining code corresponding to the equipment control sub-process;
generating an encoding configuration file corresponding to the control process according to the code corresponding to each equipment control sub-process and the execution logic between each equipment control sub-process; and
controlling the equipment according to the encoding configuration file.

In another respect, the embodiments of the present disclosure provide an equipment control apparatus, including:
at least one processor; at least one memory; and a control dividing module, a code obtaining module, a configuration generating module and an equipment control module stored in the memory when being executed by the processor.
the control dividing module is configured to determine one or more equipment control sub-process involved in control processes of equipment to be controlled and execution logic between each equipment control sub-process;
the code obtaining module is configured to obtain code corresponding to each equipment control sub-process;
the configuration generating module is configured to generate encoding configuration file corresponding to the control process according to the code corresponding to each equipment control sub-process and the execution logic between each equipment control sub-process; and
the equipment control module is configured to control the equipment to be controlled according to the encoding configuration file.

In another respect, the embodiments of the present disclosure further provide an electronic device, including memory, processor, bus and computer programs stored in the memory and can be executed by the processor, the methods above are implemented when the processor executes the programs.

In another respect, the embodiments of the present disclosure further provide a storage medium, in which computer programs are stored, the methods above are implemented when the programs are executed by a processor.

It can be known from the technical solutions above that, for the equipment control method, apparatus, electronic device and storage medium provided by the embodiments of the present disclosure, after each equipment control sub-process involved in the control process of the equipment to be controlled is determined, the code corresponding to each equipment control sub-process may be obtained first, and subsequently, the encoding configuration file corresponding to the equipment to be controlled is generated according to the code corresponding to each equipment control sub-process and the execution logic between each equipment control sub-process. In this way, it only needs to be hard-coded for the equipment control sub-process; for different equipments to be controlled, the corresponding codes of different equipment control sub-processes can be obtained according to the different equipment control sub-processes involved in the control processes of the different equipments to be controlled, so as to form separate encoding configuration files, which avoids the repetitive encoding for a same equipment control sub-process, has broader application scope and improves development efficiency. In addition, when the equipment control sub-process is extended or modified, it only needs to correct the code corresponding to the equipment control sub-process, which avoids the repetitive corrections, simplifies the debugging and development, and improves the development efficiency.

### BRIEF DESCRIPTION OF THE DRAWINGS

In order to more clearly describe the embodiments of the present disclosure or the technical solutions in the prior art, the drawings to be used in describing the embodiments or the prior art will be briefly described below, obviously, the drawings in the following description are some embodiments of the present disclosure, for those of ordinary skill in the art, other drawings may also be obtained based on these drawings without any creative work.

FIG. 1 illustrates an exemplary flowchart of the equipment control method according to an embodiment of the present disclosure;

FIG. 2 illustrates a schematic diagram of the subdivided categories of the equipment control sub-process of an embodiment of the present disclosure;

FIG. 3 illustrates a schematic diagram of the execution logic of Operation of an embodiment of the present disclosure;

FIG. 4 illustrates a schematic diagram of the execution logic of the Flow of an embodiment of the present disclosure;

FIG. 5 illustrates a structural diagram of the logical binary tree of the Flow of an embodiment of the present disclosure;

FIG. 6 illustrates a structural diagram of the logical binary tree of the Operation of an embodiment of the present disclosure;

FIG. 7 illustrates a structural diagram of the logical binary tree of the Action of an embodiment of the present disclosure;

FIG. 8 illustrates a structural diagram of the equipment control apparatus of an embodiment of the present disclosure;

FIG. 9 illustrates a physical structure diagram of the electronic device according to an embodiment of the present disclosure.

### DETAILED DESCRIPTION

The technical solutions of the present disclosure will be described clearly and completely with reference to the accompanying drawings hereinafter. Obviously, the described embodiments are merely some but not all of the embodiments of the present disclosure. On the basis of the embodiments of the present disclosure, all other embodiments obtained by the person of ordinary skill in the art without creative work shall fall within the protection scope of the present disclosure.

The terms “module”, “device” and the like, as used herein, are intended to comprise computer-related entities such as but not limited to hardware, firmware, the combination of hardware and software, software, or software in execution. For example, a module may be, but is not limited to, a process running on a processor, a processor, an object, an executable program, a thread in execution, a program and/or a computer. For example, both the application program running on a computing device and the computing device can be a module. One or more modules may be within a process and/or thread in execution, and a module may also be on a computer and/or distributed between two or more computers.

The technical solutions of the present disclosure are described in detail with reference to the accompanying drawings hereinafter.

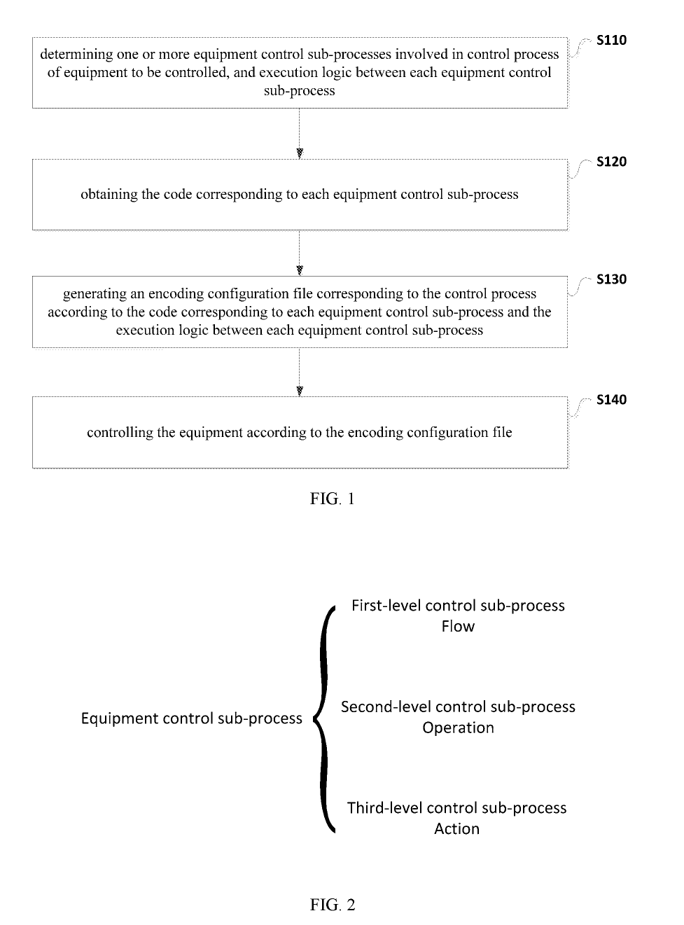

FIG. 1 illustrates an exemplary flowchart of the equipment control method according to an embodiment of the present disclosure.

As shown in FIG. 1, an equipment control method provided by an embodiment of the present disclosure may include the following steps:

S110: determining one or more equipment control sub-processes involved in the control process of the equipment to be controlled and the execution logic between each equipment control sub-process.

The embodiments of the present disclosure are applicable to different types or models of equipments in the photovoltaic semiconductor production process. The equipment to be controlled may be specifically MOCVD (Metal-Organic Chemical Vapor Deposition) equipment, PVD (Physical Vapor Deposition) equipment, ELO (Epitaxial Lift-Off) equipment, polisher equipment, inkjet printing equipment, or cleaning equipment.

The equipment control sub-process includes at least one of the following:
loading/unloading of substrate, selecting of substrate loading tool, transferring of substrate or substrate loading tool, pressure control, temperature control, heating, cooling, epitaxial lift-off, gas control, valve control, grinding, cleaning and drying, inkjet printing, and etching.

Taking MOCVD equipment as an example, the equipment control sub-process involved in the control process of the MOCVD equipment may include at least one of the following:
loading/unloading of substrate, selecting of substrate loading tool, transferring of substrate or substrate loading tool, pressure control, temperature control, heating, cooling, gas control, valve control and so on.

In an embodiment of the present disclosure, when determining each control sub-process involved in the control process of the equipment to be controlled, the execution logic between each equipment control sub-process also needs to be further determined. Wherein, the execution logic between each equipment control sub-process may include but not limited to: sequence structure, selection structure, loop structure.

S120: obtaining the code corresponding to each equipment control sub-process.

Specifically, after determining one or more equipment control sub-processes involved in the control process of the equipment to be controlled through step S110, the code corresponding to each equipment control sub-process may be obtained.

In an embodiment of the present disclosure, the equipment control sub-processes involved in the photovoltaic semiconductor preparation process may be separately encoded in advance and stored in a preset process code library.

For example, the equipment control sub-process “loading/unloading of substrate” is separately developed to obtain the code corresponding to the equipment control sub-process “loading/unloading of substrate”. The equipment control sub-process “transferring of substrate loading tool” is separately developed to obtain the code corresponding to the equipment control sub-process “transferring of substrate loading tool”.

In this way, after determining the equipment control sub-processes involved in the equipment to be controlled, the code corresponding to each equipment control sub-process may be found out from the preset process code library. In practical applications, other methods (which will be described later with embodiments) may also be used to obtain the codes corresponding to the equipment control sub-processes.

S130: generating the encoding configuration file corresponding to the control process of the equipment to be controlled according to the code corresponding to each equipment control sub-process, and the execution logic between each equipment control sub-process.

Specifically, after obtaining the code corresponding to each equipment control sub-process involved in the control process of the equipment to be controlled through step S120, the logic code corresponding to the control process of the equipment to be controlled may be generated according to the execution logic between each equipment control sub-process; subsequently, the encoding configuration file corresponding to the equipment to be controlled is generated according to the logic code corresponding to the control process of the equipment to be controlled, and the code corresponding to each equipment control sub-process.

Alternatively, in an embodiment of the present disclosure, after obtaining the code corresponding to each equipment control sub-process through step S120, the logic code corresponding to the control process may be found out from the logic code library; subsequently, the encoding configuration file corresponding to control process of the equipment to be controlled is generated according to the code corresponding to each equipment control sub-process, and the logic code corresponding to the control process of the equipment to be controlled.

In practical applications, the execution logic between each equipment control sub-process may be predetermined, and the logic code corresponding to the control process of the equipment to be controlled is generated according to the execution logic between each equipment control sub-process, and stored in a preset logic code library. The unique identifier and the corresponding logic code of the control process of the equipment to be controlled are stored in the logic code library.

Wherein, the execution logic between each equipment control sub-process may include but not limited to: sequence structure, selection structure, and loop structure.

S140: controlling the equipment to be controlled according to the encoding configuration file.

Specifically, after obtaining the encoding configuration file corresponding to the control process of the equipment to be controlled through step S130, the encoding configuration file corresponding to the control process is executed in the equipment to be controlled, so as to control the equipment to be controlled.

For example, as for an MOCVD equipment, since the equipment control sub-processes have been developed, the equipment control sub-processes involved in the MOCVD equipment are not necessary to be separately developed, and the MOCVD equipment can be controlled by directly configuring an encoding configuration file needed by the MOCVD equipment. Similarly, as for an PVD equipment, since the equipment control sub-processes thereof are similar or same with the MOCVD equipment, it is not needed to repetitively encode the developed equipment control sub-processes either; and the PVD equipment can be controlled only by separately configuring an encoding configuration file for the PVD equipment according to each equipment control sub-process involved in the PVD equipment. The control of the MOCVD equipment and the PVD equipment above does not require repetitive encoding for a same equipment control sub-process. Instead, it configures separate encoding configuration files according to the codes of different equipment control sub-processes, which greatly improves the research and development efficiency.

Referring to the description above, in the equipment control method provided by the embodiments of the present disclosure, after each equipment control sub-process involved in the control process of the equipment to be controlled is determined, the code corresponding to each equipment control sub-process may be obtained first, and subsequently, the encoding configuration file corresponding to the equipment to be controlled is generated according to the code corresponding to each equipment control sub-process, and the execution logic between each equipment control sub-process. In this way, it only needs to be hard-coded for the equipment control sub-process; for different equipments to be controlled, the corresponding codes of different equipment control sub-processes can be obtained according to the different equipment control sub-processes involved in the control processes of the different equipments to be controlled, so as to form separate encoding configuration files, which avoids the repetitive encoding for a same equipment control sub-process, has broader application scope and improves development efficiency. In addition, when the equipment control sub-process is extended or modified, it only needs to correct the code corresponding to the equipment control sub-process, which avoids the repetitive corrections, simplifies the debugging and development, and improves the development efficiency.

Based on the embodiments above, in the equipment control method provided by another embodiment of the present disclosure, obtaining the code corresponding to the equipment control sub-process specifically includes:

Dividing the equipment control sub-process into one or more first-level control sub-process Flows, and recording the execution logic between each Flow; obtaining the code corresponding to each Flow; generating the code corresponding to the equipment control sub-process according to the code corresponding to each Flow and the execution logic between each Flow.

In an embodiment of the present disclosure, each equipment control sub-process may be divided layer-by-layer, classified in detail and extracted with commonalities.

For example, it may be divided into two layers, three layers, four layers or more layers.

An embodiment of the present disclosure will be described hereinafter by taking three layers as an example.

For example, as for each equipment control sub-process involved in the equipment to be controlled, it may be divided in detail into three categories: first-level control sub-process Flow, second-level control sub-process Operation, third-level control sub-process Action (atomic action), as shown in FIG. 2. FIG. 2 illustrates a schematic diagram of the subdivided categories of the equipment control sub-process of an embodiment of the present disclosure.

Wherein, Action is the smallest category, which is atomic action and cannot be divided further; Operation accomplishes a complex operation by multiple Actions together; Flow consists of multiple Operations, so as to accomplish a more complex process.

In an embodiment of the present disclosure, different results after executing Action can be the entities to be controlled.

In practical applications, Operation may also include one or more entities to be controlled in addition to each Action. Flow may further include one or more entities to be controlled in addition to each Operation.

The entity to be controlled may include at least one of the following: discrete date, cluster data, message, alarm.

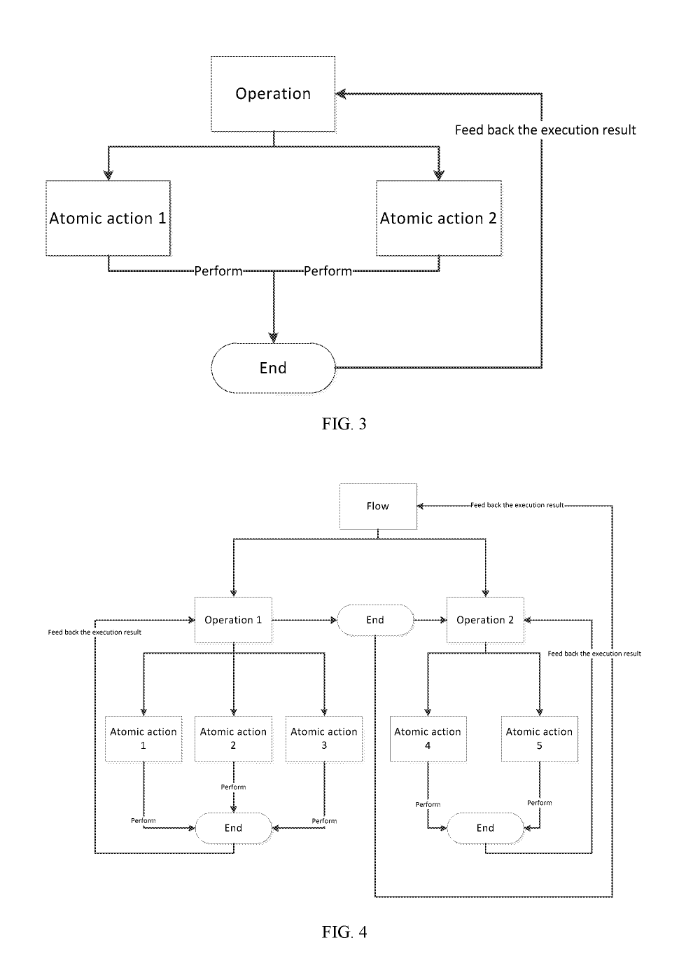

In practical applications, as for different Operations, the Actions involved are different, and the execution logic between multiple Actions are also different. FIG. 3 illustrates a schematic diagram of the execution logic of Operation of an embodiment of the present disclosure.

Further, as for different Flows, the Operations involved are different, and the execution logic between multiple Operations are also different. FIG. 4 illustrates a schematic diagram of the execution logic of the Flow of an embodiment of the present disclosure.

Since there may be same or similar Flows in different equipment control sub-processes, in an embodiment of the present disclosure, different Flows can be separately encoded in advance and stored in the preset process code library.

In this way, after obtaining one or more Flows by dividing the equipment control sub-processes, the code corresponding to each Flow can be found out from the preset process code library.

In practical applications, the unique corresponding identifier may be set for different Flows; correspondingly, according to the unique corresponding identifier of the Flow, the code corresponding to the identifier is found out from the preset process code library as the code corresponding to the Flow.

Sequentially, the code corresponding to the equipment control sub-process may be generated according to the code corresponding to each Flow, and the execution logic between each Flow.

Other steps of the embodiment of the present disclosure are similar to the steps of the foregoing embodiments, the embodiment of the present disclosure is not going to describe repeatedly.

By subdividing the equipment control sub-process courses, and encoding the equipment control sub-processes according to separately encoded Flows, the equipment control method provided by the embodiments of the present disclosure is able to solve the problems of multiple developments of the equipment control sub-processes, and repeated modifications due to the demands or design flaws, while performing refined operations.

Based on the embodiments above, in the equipment control method provided by another embodiment of the present disclosure, obtaining the code corresponding to the Flow includes:

Dividing the Flow into one or more second-level control sub-process Operations, and recording the execution logic between each Operation; searching for the configuration item matching the Operation and the execution logic between Operations from the process code library; and determining the code corresponding to the configuration item in the process code library as the code corresponding to the Flow.

In an embodiment of the present disclosure, if the corresponding code cannot be obtained directly according to the identifier of the Flow, one or more Operations involved in the Flow and the execution logic between each Operation may be obtained by further dividing each Flow, after obtaining one or more Flows by dividing the equipment control sub-processes involved in the control process of the equipment to be controlled.

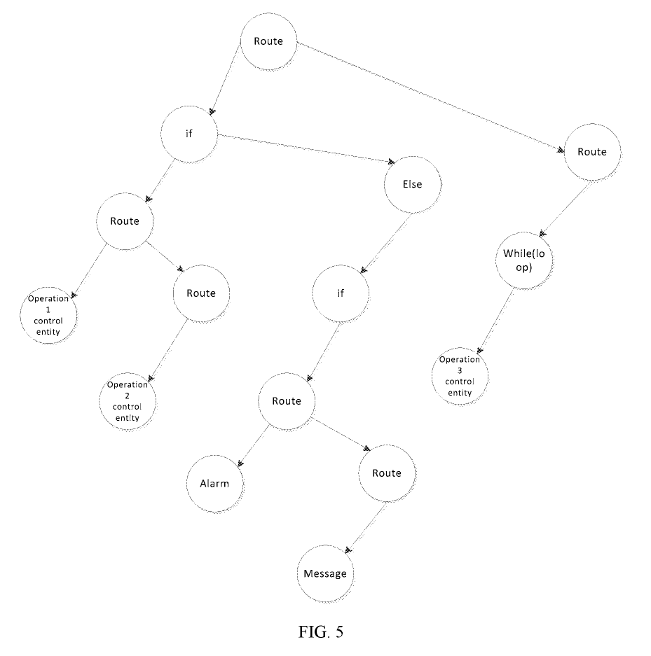

In an embodiment of the present disclosure, the execution logic between each Operation may be represented with binary tree, as shown in FIG. 5. FIG. 5 illustrates a structural diagram of the logical binary tree of the Flow of an embodiment of the present disclosure.

In an embodiment of the present disclosure, configuration items of multiple levels are set in the process code library, including: configuration item of Flow layer, configuration item of Operation layer, configuration item of Action layer.

The process code library includes the codes corresponding to multiple configuration items.

For each configuration item, the process code library stores the sub-items involved in the configuration item, and the execution logic between each sub-item, in addition to the code corresponding to the configuration item.

Wherein, for the configuration items of different levels, the sub-items included have different levels. For example, for the configuration item of Flow layer, the level of the sub-item included is Operation layer, such as that, for a configuration item of Flow layer, the involved sub-items stored in the process code library are specifically one or more Operations; for the configuration item of Operation layer, the level of the sub-item included is Action layer, such as that, for a configuration item of Operation layer, the involved sub-items stored in the process code library are specifically one or more Actions.

In this way, according to each Operation involved in the Flow, and the execution logic between each Operation, the matched configuration item is founded from the code library, and the code corresponding to the configuration item is determined as the code corresponding to the Flow.

Specifically, after obtaining each Operation involved and the execution logic between each Operation by dividing each Flow, each Operation involved and the execution logic between each Operation by dividing each Flow may be matched with the configuration items of Flow layer in the process code library, if there is a configuration item in the code library matches the Operations involved in the Flow, and the execution logic between each matched sub-item matches the execution logic between each Operation, the code corresponding to the configuration item can be determined as the code corresponding to the Flow.

Other steps of the embodiment of the present disclosure are similar to the steps of the foregoing embodiments, the embodiment of the present disclosure is not going to describe repeatedly.

By subdividing each Flow course involved in the equipment control sub-processes, and encoding the Flows according to separately encoded configuration items so as to encode the equipment control sub-processes, the equipment control method provided by the embodiments of the present disclosure is able to solve the problems of multiple developments of each Flow, and repeated modifications due to the demands or design flaws, while performing refined operations.

Based on each embodiment above, in the equipment control method provided by another embodiment of the present disclosure, obtaining the code corresponding to the Flow further includes:

Obtaining the code corresponding to each Operation, if the configuration items matching the Operations and the execution logic between Operations are not found from the process code library; generating the code corresponding to the Flow according to the code corresponding to each Operation and the logic between each Operation.

Since there may be same or similar Operations in different Flows, in an embodiment of the present disclosure, different Operations can be separately encoded in advance and stored in the preset process code library.

In this way, if the configuration items matching the Operations and the execution logic between Operations are not found from the process code library, the code corresponding to each Operation involved in the Flow may be found out from the preset process code library.

In practical applications, the unique corresponding identifier may be set for different Operations; correspondingly, according to the unique corresponding identifier of the Operation, the code corresponding to the identifier is found out from the preset process code library as the code corresponding to the Operation.

Sequentially, the code corresponding to the Flow may be generated according to the code corresponding to each Operation, and the execution logic between each Operation. Of course, in practical applications, when the Flow includes one or more entities to be controlled in addition to each Operation, the code corresponding to the Flow can be generated according to the code corresponding to each Operation, the execution logic between each Operation, the execution logic between the entities to be controlled and the execution logic between the entities to be controlled and the Operations.

Other steps of the embodiment of the present disclosure are similar to the steps of the foregoing embodiments, the embodiment of the present disclosure is not going to describe repeatedly.

By subdividing each Flow course involved in the equipment control sub-processes, and encoding the Flows according to separately encoded Operations so as to encode the equipment control sub-processes, the equipment control method provided by the embodiments of the present disclosure is able to solve the problems of multiple developments of each Flow, and repeated modifications due to the demands or design flaws, while performing refined operations.

Based on the embodiments above, in the equipment control method provided by another embodiment of the present disclosure, obtaining the code corresponding to the Operation includes:

Dividing the Operation into one or more Actions, and recording the execution logic between each Action; searching for the configuration item matching the Action and the execution logic between Actions from the process code library; determining the code corresponding to the configuration item in the process code library as the code corresponding to the Operation.

In an embodiment of the present disclosure, if the corresponding code cannot be obtained directly according to the identifier of the Operation, one or more Actions involved in the Operation and the execution logic between each Action may be obtained by further dividing each Operation, after obtaining one or more Operations by dividing the Flow.

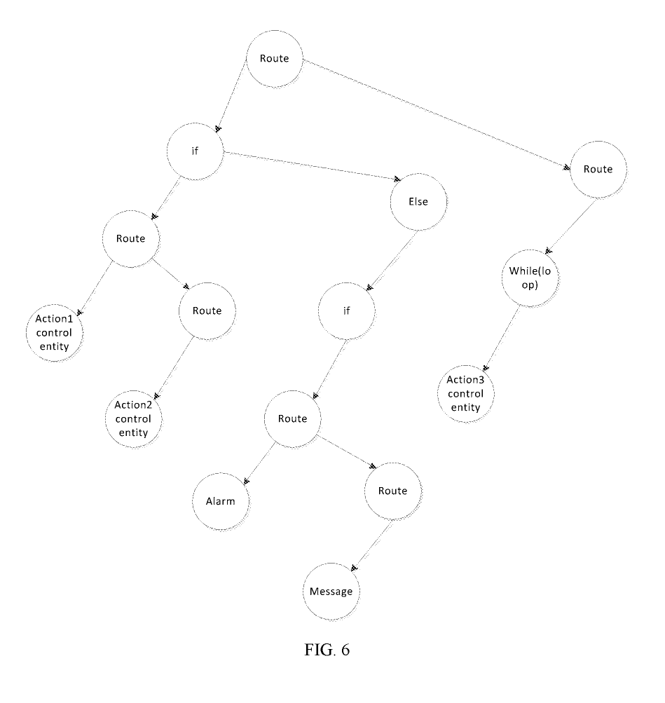

In an embodiment of the present disclosure, the execution logic between each Action may be represented with binary tree, as shown in FIG. 6. FIG. 6 illustrates a structural diagram of the logical binary tree of the Operation of an embodiment of the present disclosure.

In an embodiment of the present disclosure, configuration items of multiple levels are set in the process code library, including: configuration item of Flow layer, configuration item of Operation layer, configuration item of Action layer.

For each configuration item, the process code library stores the sub-items involved in the configuration item, and the execution logic between each sub-item, in addition to the code corresponding to the configuration item.

Wherein, for the configuration items of different levels, the sub-items included have different levels. For example, the level of the sub-items included in the configuration item of Flow layer is Operation level; the level of the sub-items included in the configuration item of Operation layer is Action level.

In this way, according to each Action involved in the Operation, and the execution logic between each Action, the matched configuration item is found from the code library, and the code corresponding to the configuration item is determined as the code corresponding to the Operation.

Specifically, after obtaining each Action involved and the execution logic between each Action by dividing each Operation, each Action involved and the execution logic between each Action involved in the Operation may be matched with the configuration items of Operation layer in the process code library. If there is a configuration item in the code library matches the Actions involved in the Operation, and the execution logic between each matched sub-item matches the execution logic between each Action, the code corresponding to the configuration item can be determined as the code corresponding to the Operation.

Other steps of the embodiment of the present disclosure are similar to the steps of the foregoing embodiments, the embodiment of the present disclosure is not going to describe repeatedly.

By subdividing each Operation course involved in the Flow, and encoding the Operations according to separately encoded configuration items so as to encode the Flows and the equipment control sub-processes, the equipment control method provided by the embodiments of the present disclosure is able to solve the problems of multiple developments of each Operation, and repeated modifications due to the demands or design flaws.

Based on each embodiment above, in the equipment control method provided by another embodiment of the present disclosure, obtaining the code corresponding to the Operation further includes:

Searching for the code corresponding to the Action from the process code library, if the configuration items matching the Actions and the execution logic between Actions are not found from the process code library; generating the code corresponding to the Operation according to the code corresponding to each Action and the logic between each Action.

Wherein, the code corresponding to the Action is preset and stored according to one or more involved entities to be controlled and the execution logic between each entity to be controlled; the entity to be controlled includes at least one of the following: discrete data, cluster data, message, and alarm.

Since there may be same or similar Actions in different Operations, in an embodiment of the present disclosure, different Actions can be separately encoded in advance and stored in the preset process code library.

In this way, if the configuration items matching the Actions and the execution logic between Actions are not found from the process code library, the code corresponding to each Action involved in the Operation may be found out from the preset process code library.

In practical applications, the unique corresponding identifier may be set for different Actions; correspondingly, according to the unique corresponding identifier of the Action, the code corresponding to the identifier is found out from the preset process code library as the code corresponding to the Action.

Sequentially, the code corresponding to the Operation may be generated according to the code corresponding to each Action, and the execution logic between each Action. Of course, in practical applications, when the Operation includes one or more entities to be controlled in addition to each Action, the code corresponding to the Operation can be generated according to the code corresponding to each Action, the execution logic between each Action, the execution logic between the entities to be controlled and the execution logic between the entities to be controlled and the Actions.

In an embodiment of the present disclosure, Action is the smallest category of equipment control sub-process, which is atomic action and cannot be divided further. Therefore, the code corresponding to the Action is preset and stored according to one or more involved entities to be controlled (Discrete Date, Cluster Data, Message, Alarm) and the execution logic between each entity to be controlled.

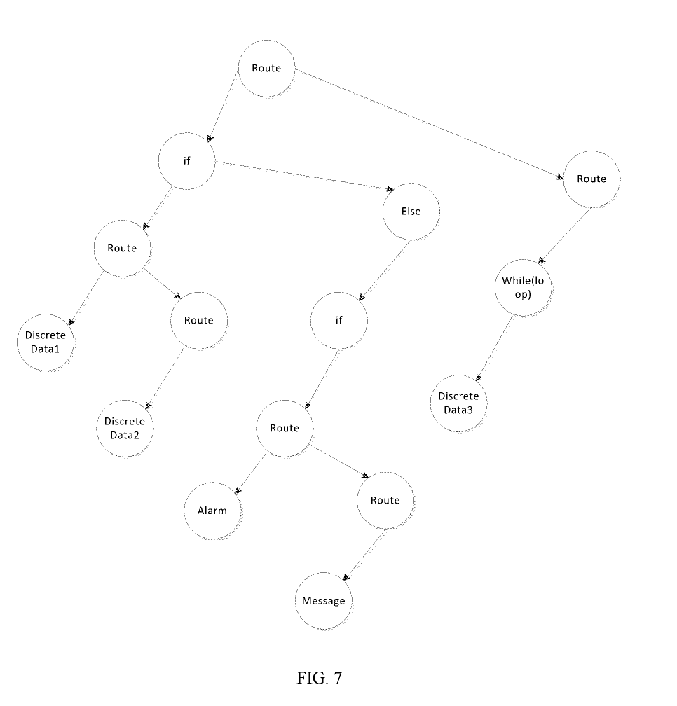

In an embodiment of the present disclosure, the execution logic between each entity to be controlled may be represented with binary tree, as shown in FIG. 7. FIG. 7 illustrates a structural diagram of the logical binary tree of the Action of an embodiment of the present disclosure.

Other steps of the embodiment of the present disclosure are similar to the steps of the foregoing embodiments, the embodiment of the present disclosure is not going to describe repeatedly.

By encoding the Operations according to separately encoded Actions so as to encode the Flows and the equipment control sub-processes, the equipment control method provided by the embodiments of the present disclosure is able to solve the problems of multiple developments of each Action, and repeated modifications due to the demands or design flaws, while performing refined operations.

Based on the embodiments above, another embodiment of the present disclosure provides an equipment control apparatus.

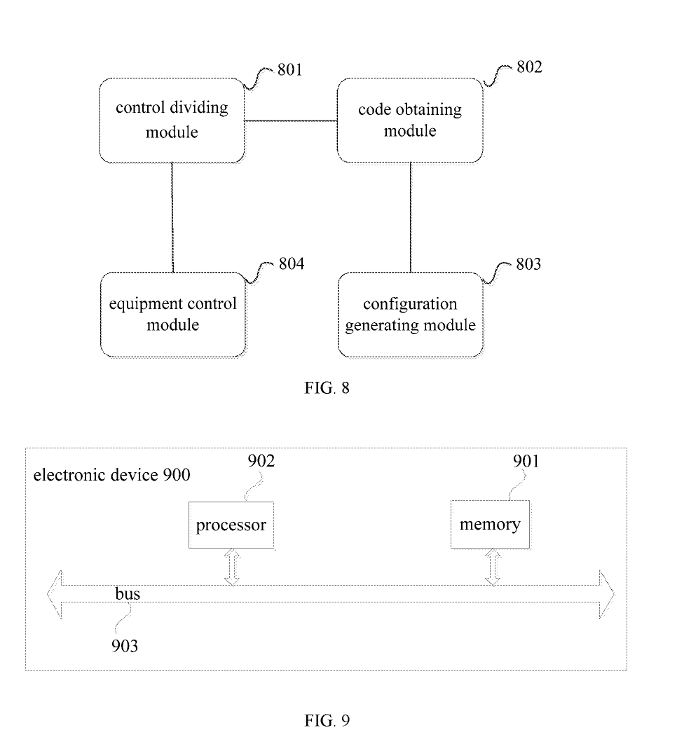

FIG. 8 illustrates a structural diagram of the equipment control apparatus of an embodiment of the present disclosure.

As shown in FIG. 8, the equipment control apparatus 800 provided by the embodiment of the present disclosure may include a control dividing module 801, a code obtaining module 802, a configuration generating module 803 and an equipment control module 804.

It should be noted that the equipment control apparatus 800 also includes at least one processor and at least one memory (not shown in FIG. 8); the modules above are stored in the memory, and when being executed by the processor,
the control dividing module 801 is configured to determine one or more equipment control sub-processes involved in the control process of the equipment to be controlled and the execution logic between each equipment control sub-process.
the code obtaining module 802 is configured to obtain the code corresponding to each equipment control sub-process.
the configuration generating module 803 is configured to generate the encoding configuration file corresponding to the control process of the equipment to be controlled according to the code corresponding to each equipment control sub-process and the execution logic between each equipment control sub-process.

The equipment control module 804 is configured to control the equipment to be controlled according to the encoding configuration file.

Alternatively, the equipment to be controlled may be specifically Metal-Organic Chemical Vapor Deposition (MOCVD) equipment, Physical Vapor Deposition (PVD) equipment, Epitaxial Lift-Off (ELO) equipment, polisher equipment, inkjet printing equipment, or cleaning equipment.

The equipment control sub-process includes at least one of the following:
loading/unloading of substrate, selecting of substrate loading tool, transferring of substrate or substrate loading tool, pressure control, temperature control, heating, cooling, epitaxial liftoff, gas control, valve control, grinding, cleaning and drying, inkjet printing, etching.

Alternatively, the code obtaining module 802 may divide the equipment control sub-process into one or more first-level control sub-process Flows, and recording the execution logic between each Flow; obtain the code corresponding to each Flow; generate the code corresponding to the equipment control sub-process according to the code corresponding to each Flow and the execution logic between each Flow.

Alternatively, the code obtaining module 802 may divide the Flow into one or more second-level control sub-process Operations, and record the execution logic between each Operation; search for the configuration item matching the Operation and the execution logic between Operations from the process code library; the process code library includes: codes corresponding to multiple configuration items, sub-items involved in each configuration item, and execution logic between each sub-item; determine the code corresponding to the configuration item in the process code library as the code corresponding to the Flow.

Alternatively, the code obtaining module 802 may obtain the code corresponding to each Operation, if the configuration items matching the Operations and the execution logic between Operations are not found from the process code library; generate the code corresponding to the Flow according to the code corresponding to each Operation and the logic between each Operation.

Alternatively, the code obtaining module 802 may divide the Operation into one or more Actions, and record the execution logic between each Action; find out the configuration item matching the Action and the execution logic between Actions from the process code library; determine the code corresponding to the configuration item in the process code library as the code corresponding to the Operation.

Alternatively, the code obtaining module 802 may find the code corresponding to the Action from the process code library, if the configuration items matching the Actions and the execution logic between Actions are not found from the process code library; generate the code corresponding to the Operation according to the code corresponding to each Action and the logic between each Action.

Wherein, the code corresponding to the Action is preset and stored according to one or more involved entities to be controlled and the execution logic between each entity to be controlled.

The entity to be controlled includes at least one of the following: discrete data, cluster data, message, and alarm.

The control process processing device provided by the embodiments of the present disclosure is applicable to performing the methods of the embodiments above, the present embodiment will not describe repetitively.

In the equipment control apparatus, after each equipment control sub-process involved in the control process of the equipment to be controlled is determined, the code corresponding to each equipment control sub-process may be obtained first, and subsequently, the encoding configuration file corresponding to the equipment to be controlled is generated according to the code corresponding to each equipment control sub-process and the execution logic between each equipment control sub-process. In this way, it only needs to be hard-coded for the equipment control sub-process; for different equipments to be controlled, the corresponding codes of different equipment control sub-processes can be obtained according to the different equipment control sub-processes involved in the control processes of the different equipments to be controlled, so as to form separate encoding configuration files, which avoids the repetitive encoding for a same equipment control sub-process, has broader application scope and improves development efficiency. In addition, when the equipment control sub-process is extended or modified, it only needs to correct the code corresponding to the equipment control sub-process, which avoids the repetitive corrections, simplifies the debugging and development, and improves the development efficiency.

FIG. 9 illustrates a physical structure diagram of the electronic device according to an embodiment of the present disclosure. As shown in FIG. 9, the electronic device 900 may include: memory 901, processor 902, bus 903 and computer programs stored in the memory 901, which can be executed by the processor 902. Wherein, the memory 901 and the processor 902 communicates with each other through the bus 903.

The processor 902 is configured to call the program instructions in the memory 901 to implement the method as shown in FIG. 1 when executing the program:
determining one or more equipment control sub-processes involved in the control process of the equipment to be controlled and the execution logic between each equipment control sub-process;
obtaining the code corresponding to each equipment control sub-process;
generating the encoding configuration file corresponding to the control process of the equipment to be controlled according to the code corresponding to each equipment control sub-process and the execution logic between each equipment control sub-process;
controlling the equipment to be controlled according to the encoding configuration file.

In another embodiment, the equipment to be controlled may be specifically Metal-Organic Chemical Vapor Deposition (MOCVD) equipment, Physical Vapor Deposition (PVD) equipment, Epitaxial Lift-Off (ELO) equipment, polisher equipment, inkjet printing equipment, or cleaning equipment.

The equipment control sub-process includes at least one of the following:
loading/unloading of substrate, selecting of substrate loading tool, transferring of substrate or substrate loading tool, pressure control, temperature control, heating, cooling, epitaxial liftoff, gas control, valve control, grinding, cleaning and drying, inkjet printing, and etching.

In another embodiment, the processor 902 implements the method as follows when executing the program:
obtaining the code corresponding to the equipment control sub-process, including:
dividing the equipment control sub-process into one or more first-level control sub-process Flows, and recording the execution logic between each Flow;
obtaining the code corresponding to each Flow;
generating the code corresponding to the equipment control sub-process according to the code corresponding to each Flow and the execution logic between each Flow.

In another embodiment, the processor 902 implements the method as follows when executing the program:
obtaining the code corresponding to the flow includes:
dividing the Flow into one or more second-level control sub-process Operations, and recording the execution logic between each Operation;
searching for the configuration item matching the Operation and the execution logic between Operations from the process code library; the process code library includes: codes corresponding to multiple configuration items, sub-items involved in each configuration item, and execution logic between each sub-item;
determining the code corresponding to the configuration item in the process code library as the code corresponding to the Flow.

In another embodiment, the processor 902 implements the method as follows when executing the program:
obtaining the code corresponding to the flow further includes:
if the configuration items matching the Operations and the execution logic between Operations are not found from the process code library,
obtaining the code corresponding to each Operation;
generating the code corresponding to the Flow according to the code corresponding to each Operation and the logic between each Operation.

In another embodiment, the processor 902 implements the method as follows when executing the program:
obtaining the code corresponding to the Operation includes:
dividing the Operation into one or more Actions, and recording the execution logic between each Action;
searching for the configuration item matching the Action and the execution logic between Actions from the process code library;
determining the code corresponding to the configuration item in the process code library as the code corresponding to the Operation.

In another embodiment, the processor 902 implements the method as follows when executing the program:
obtaining the code corresponding to the Operation further includes:
if the configuration items matching the Actions and the execution logic between Actions are not found from the process code library,
searching for the code corresponding to the Action from the process code library;
generating the code corresponding to the Operation according to the code corresponding to each Action and the logic between each Action;
wherein, the code corresponding to the Action is preset and stored according to one or more involved entities to be controlled and the execution logic between each entity to be controlled; the entity to be controlled includes at least one of the following:
discrete data, cluster data, message, and alarm.

The electronic device provided by the embodiments of the present disclosure is applicable to executing the programs corresponding to the methods of the embodiments above, the present embodiment will not describe repetitively.

The electronic device provided by the embodiments of the present disclosure has at least the following technical effects: separately hard-coding the equipment control sub-processes; for different equipments to be controlled, the corresponding codes of different equipment control sub-processes can be obtained according to the different equipment control sub-processes involved in the control processes of the different equipments to be controlled, so as to form separate encoding configuration files, which avoids the repetitive encoding for a same equipment control sub-process, has broader application scope and improves development efficiency. In addition, when the equipment control sub-process is extended or modified, it only needs to correct the code corresponding to the equipment control sub-process, which avoids the repetitive corrections, simplifies the debugging and development, and improves the development efficiency.

Another embodiment of the present disclosure provides a storage medium, in which computer programs are stored, the method as shown in FIG. 1 is implemented when the programs are executed by the processor:
determining one or more equipment control sub-processes involved in the control process of the equipment to be controlled, and the execution logic between each equipment control sub-process;
obtaining the code corresponding to each equipment control sub-process;
generating the encoding configuration file corresponding to the control process of the equipment to be controlled according to the code corresponding to each equipment control sub-process, and the execution logic between each equipment control sub-process;
controlling the equipment to be controlled according to the encoding configuration file.

In another embodiment, the equipment to be controlled may be specifically Metal-Organic Chemical Vapor Deposition (MOCVD) equipment, Physical Vapor Deposition (PVD) equipment, Epitaxial Lift-Off (ELO) equipment, polisher equipment, inkjet printing equipment, or cleaning equipment.

The equipment control sub-process includes at least one of the following:
loading/unloading of substrate, selecting of substrate loading tool, transferring of substrate or substrate loading tool, pressure control, temperature control, heating, cooling, epitaxial liftoff, gas control, valve control, grinding, cleaning and drying, inkjet printing, etching.

In another embodiment, the method as follows is implemented when the programs are executed by the processor:
obtaining the code corresponding to the equipment control sub-process, including:
dividing the equipment control sub-process into one or more first-level control sub-process Flows, and recording the execution logic between each Flow;
obtaining the code corresponding to each Flow;
generating the code corresponding to the equipment control sub-process according to the code corresponding to each Flow and the execution logic between each Flow.

In another embodiment, the method as follows is implemented when the programs are executed by the processor:
obtaining the code corresponding to the flow includes:
dividing the Flow into one or more second-level control sub-process Operations, and recording the execution logic between each Operation;
searching for the configuration item matching the Operation and the execution logic between Operations from the process code library; the process code library includes: codes corresponding to multiple configuration items, sub-items involved in each configuration item, and execution logic between each sub-item;
determining the code corresponding to the configuration item in the process code library as the code corresponding to the Flow.

In another embodiment, the method as follows is implemented when the programs are executed by the processor:
obtaining the code corresponding to the flow further includes:
if the configuration items matching the Operations and the execution logic between Operations are not found from the process code library,
obtaining the code corresponding to each Operation;
generating the code corresponding to the Flow according to the code corresponding to each Operation and the logic between each Operation.

In another embodiment, the method as follows is implemented when the programs are executed by the processor:
obtaining the code corresponding to the Operation includes:
dividing the Operation into one or more Actions, and recording the execution logic between each Action;
searching for the configuration item matching the Action and the execution logic between Actions from the process code library;
determining the code corresponding to the configuration item in the process code library as the code corresponding to the Operation.

In another embodiment, the method as follows is implemented when the programs are executed by the processor:
obtaining the code corresponding to the Operation further includes:
if the configuration items matching the Actions and the execution logic between Actions are not found from the process code library,
searching for the code corresponding to the Action from the process code library;
generating the code corresponding to the Operation according to the code corresponding to each Action and the logic between each Action;
wherein, the code corresponding to the Action is preset and stored according to one or more involved entities to be controlled and the execution logic between each entity to be controlled; the entity to be controlled includes at least one of the following:
discrete data, cluster data, message, and alarm.

As for the storage medium provided by the embodiments of the present disclosure, the methods of the embodiments above are implemented when the programs are executed by the processor, the present embodiment will not describe repetitively.

As for the storage medium provided by the embodiments of the present disclosure, when the programs are executed by the processor, the equipment control sub-processes are separately hard-coded; for different equipments to be controlled, the corresponding codes of different equipment control sub-processes can be obtained according to the different equipment control sub-processes involved in the control processes of the different equipments to be controlled, so as to form separate encoding configuration files, which avoids the repetitive encoding for a same equipment control sub-process, has broader application scope and improves development efficiency. In addition, when the equipment control sub-process is extended or modified, it only needs to correct the code corresponding to the equipment control sub-process, which avoids the repetitive corrections, simplifies the debugging and development, and improves the development efficiency.

Another embodiment of the present invention discloses a computer program product including computer programs stored in a non-transitory computer readable storage medium, the computer programs including program instructions. When the program instructions are executed by a computer, the methods provided by each embodiment above can be implemented, the methods, for example, include:
determining one or more equipment control sub-processes involved in the control process of the equipment to be controlled, and the execution logic between each equipment control sub-process; obtaining the code corresponding to each equipment control sub-process; generating the encoding configuration file corresponding to the control process of the equipment to be controlled according to the code corresponding to each equipment control sub-process, and the execution logic between each equipment control sub-process; controlling the equipment to be controlled according to the encoding configuration file.

It will be understood by those skilled in the art that, although some embodiments described herein include certain features included in other embodiments, rather than other features, the combinations of features of different embodiments are intended to be within the scope of the present disclosure, and different embodiments are formed therewith.

Those skilled in the art can understand that, each step in the embodiments may be implemented with hardware, or software modules running on one or more processors, or the combinations thereof. Those skilled in the art should understand that, a microprocessor or digital signal processor (DSP) may be used in practice to implement some or all of the functions of some or all of the components according to the embodiments of the present disclosure. The present disclosure may also be implemented as a device or a device program (such as a computer program or a computer program product) for performing part or all of the methods described herein.

Although the embodiments of the present disclosure have been described in conjunction with the drawings, various modifications and variations may be made by those skilled in the art without departing from the spirit and scope of the present disclosure, and such modifications and variations are within the scope defined by the appended claims.

1. An method for controlling equipment, comprising:
determining one or more equipment control sub-processes involved in control process of equipment to be controlled and execution logic between each equipment control sub-process;
for each of the equipment control sub-process, obtaining code corresponding to the equipment control sub-process;
generating an encoding configuration file corresponding to the control process according to the code corresponding to each equipment control sub-process and the execution logic between each equipment control sub-process; and
controlling the equipment according to the encoding configuration file.

2. The method of claim 1, wherein obtaining the code corresponding to the equipment control sub-process comprises:
dividing the equipment control sub-process into one or more first-level control sub-processes Flow, and recording execution logic between each Flow;
for each of the Flow, obtaining code corresponding to the Flow;
generating the code corresponding to the equipment control sub-process according to the code corresponding to each Flow and the execution logic between each Flow.

3. The method of claim 2, wherein obtaining the code corresponding to the Flow comprises:
dividing the Flow into one or more second-level control sub-processes Operation, and recording execution logic between each Operation;
searching for configuration item matching the Operation and the execution logic between Operations from a process code library; wherein the process code library includes codes corresponding to multiple configuration items, sub-items involved in each configuration item, and execution logic between each sub-item;
determining the code corresponding to the configuration item in the process code library as the code corresponding to the Flow.

4. The method of claim 3, wherein obtaining the code corresponding to the Flow further comprises:
when the configuration item matching the Operation and the execution logic between Operations are not found from the process code library,
for each of the Operation, obtaining code corresponding to the Operation;
generating the code corresponding to the Flow according to the code corresponding to each Operation and the logic between each Operation.

5. The method of claim 4, wherein obtaining the code corresponding to the Operation comprises:
dividing the Operation into one or more third-level control sub-processes Action, and recording execution logic between each Action;
searching for configuration item matching the Action and the execution logic between Actions from the process code library;
determining the code corresponding to the configuration item in the process code library as the code corresponding to the Operation.

6. The method of claim 5, wherein obtaining the code corresponding to the Operation further comprises:
when the configuration item matching the Action and the execution logic between Actions are not found from the process code library,
finding code corresponding to each Action from the process code library;
generating the code corresponding to the Operation according to the code corresponding to each Action and the logic between each Action;
wherein, the code corresponding to the Action is preset and stored according to one or more involved entities to be controlled and execution logic between each entity to be controlled; the entity to be controlled comprises at least one of the following:
discrete data, cluster data, message, and alarm.

7. The method of claim 6, wherein the equipment to be controlled is specifically Metal-Organic Chemical Vapor Deposition equipment, Physical Vapor Deposition equipment, Epitaxial Lift-Off equipment, polisher equipment, inkjet printing equipment, or cleaning equipment;
the equipment control sub-process comprises at least one of the following:
loading/unloading of substrate, selecting of substrate loading tool, transferring of substrate or substrate loading tool, pressure control, temperature control, heating, cooling, epitaxial lift-off, gas control, valve control, grinding, cleaning and drying, inkjet printing, and etching.

8. An equipment control apparatus, comprising:
At least one processor; at least one memory; and a control dividing module, a code obtaining module, a configuration generating module and an equipment control module stored in the memory, when being executed by the processor,
the control dividing module is configured to determine one or more equipment control sub-processes involved in control process of equipment to be controlled and execution logic between each equipment control sub-process;
the code obtaining module is configured to obtain code corresponding to each equipment control sub-process;
the configuration generating module is configured to generate encoding configuration file corresponding to the control process according to the code corresponding to each equipment control sub-process and the execution logic between each equipment control sub-process; and
the equipment control module is configured to control the equipment according to the encoding configuration file.

9. A storage medium, in which computer programs are stored, wherein the method of claim 1 is implemented when a processor executes the programs.
